(19) United States
(12) Patent Application Publication
(10) Pub. No.: US 2009/0041895 A1
(43) Pub. Date: Feb. 12, 2009

(54) METHOD FOR PRODUCING SOY SAUCE

(76) Inventors: Per Munk Nielsen, Hilleroed (DK); Anders Viksoe Nielsen, Slangerup (DK)

Correspondence Address: NOVOZYMES NORTH AMERICA, INC., 500 FIFTH AVENUE, SUITE 1600, NEW YORK, NY, 10110, US

(21) Appl. No.: 12/095,972

(22) PCT Filed: Jan. 3, 2007
(86) PCT No.: PCT/EP2007/050058

§ 371 Date: Jun. 3, 2008

Related U.S. Application Data
(60) Provisional application No. 60/762,714, filed on Jan. 26, 2006.

(30) Foreign Application Priority Data
Jan. 4, 2006 (DK) PA 2006 000015

(51) Int. Cl. A23L 1/238

(52) U.S. Cl. 426/46; 426/52; 426/48

(57) ABSTRACT

The invention relates to a method for producing soy sauce using an amylolytic enzyme comprising a Carbohydrate Binding Module.

### TECHNICAL FIELD

The present invention relates to a method for producing soy sauce using an amylolytic enzyme comprising a carbohydrate binding module.

### BACKGROUND OF THE INVENTION

Soy sauce is produced from soy beans and optionally other vegetable ingredients such as wheat and rice. During the process it is desired that starch and other carbohydrates are degraded into sugars that can be utilised by the microorganisms used for fermentation as energy source and substrate for formation of aroma compounds. The break down of starch is traditionally achieved by amylolytic enzymes produced by the culture used during the koji fermentation. The efficiency of starch hydrolysis is important for the production of the soy sauce.

### SUMMARY OF THE INVENTION

The inventors have found that use of amylolytic enzymes comprising a Carbohydrate Binding Module (CBM) leads to an increased rate of starch hydrolysis compared to amylolytic enzymes without CBM under conditions relevant for soy sauce production.

Consequently, the invention relates to a method for producing soy sauce, comprising: i) treating a vegetable material with an amylolytic enzyme; and ii) producing soy sauce from the treated vegetable material; wherein the amylolytic enzyme comprises a carbohydrate binding module. In further aspects, the invention relates to use of an amylolytic enzyme comprising a carbohydrate binding module for producing soy sauce, and to soy sauce obtainable by the method of the invention.

### DETAILED DISCLOSURE OF THE INVENTION

### Enzymes

Enzymes to be used in the method of the invention are amylolytic enzymes comprising a Carbohydrate Binding Module (CBM). Amylolytic enzymes are enzymes capable of degrading starch and related oligo- and polysaccharides. Preferred amylolytic enzymes are alpha-amylases (EC 3.2.1.1), beta-amylases (EC 3.2.1.2), maltogenic alpha-amylases (EC 3.2.1.133) and glucoamylases (EC 3.2.1.3). EC (Enzyme Commission) numbers refer to the enzyme definitions of the Nomenclature Committee of the International Union of Biochemistry and Molecular Biology (IUBMB).

A carbohydrate-binding module (CBM), or as often referred to, a carbohydrate-binding domain (CBD), is a polypeptide amino acid sequence which binds preferentially to a poly- or oligosaccharide (carbohydrate), frequently—but not necessarily exclusively—to a water-insoluble (including crystalline) form thereof.

CBMs derived from starch degrading enzymes are often referred to as starch-binding modules or SBMs (CBMs which may occur in certain amylolytic enzymes, such as certain glucoamylases, or in enzymes such as cyclodextrin glucanotransferases, or in endo-amylases). SBMs are often referred to as SBDs (Starch Binding Domains). Preferred for the invention are CBMs which are Starch Binding Modules.

CBMs are found as integral parts of large polypeptides or proteins consisting of two or more polypeptide amino acid sequence regions, especially in hydrolytic enzymes (hydrolases) which typically comprise a catalytic module containing the active site for substrate hydrolysis and a carbohydrate-binding module (CBM) for binding to the carbohydrate substrate in question. Such enzymes can comprise more than one catalytic module and one, two or three CBMs, and optionally further comprise one or more polypeptide amino acid sequence regions linking the CBM(s) with the catalytic module(s), a region of the latter type usually being denoted a “linker”. CBMs have also been found in algae, e.g., in the red alga Porphyra purpurea in the form of a non-hydrolytic polysaccharide-binding protein.

In proteins/polypeptides in which CBMs occur (e.g., enzymes, typically hydrolytic enzymes), a CBM may be located at the N or C terminus or at an internal position.

That part of a polypeptide or protein (e.g., hydrolytic enzyme) which constitutes a CBM per se typically consists of more than about 30 and less than about 250 amino acid residues. The “Carbohydrate-Binding Module of Family 20” or a CBM-20 module is in the context of this invention defined as a sequence of approximately 100 amino acids having at least 45% identity to the Carbohydrate-Binding Module (CBM) of the polypeptide disclosed in FIG. 1 by Joergensen et al (1997) in Biotechnol. Lett. 19:1027-1031. The CBM comprises the last 102 amino acids of the polypeptide, i.e. the subsequence from amino acid 582 to amino acid 683. The numbering of Glycoside Hydrolase Families applied in this disclosure follows the concept of Coutinho, P. M. & Henrissat, B. (1999) CAZy—Carbohydrate-Active Enzymes server at URL: http://afmb.cnrs-mrs.fr/˜cazy/CAZY/index.html or alternatively Coutinho, P. M. & Henrissat, B. 1999; The modular structure of cellulases and other carbohydrate-active enzymes: an integrated database approach. In “Genetics, Biochemistry and Ecology of Cellulose Degradation”, K. Ohmiya, K. Hayashi, K. Sakka, Y. Kobayashi, S. Karita and T. Kimura eds., Uni Publishers Co., Tokyo, pp. 15-23, and Bourne, Y. & Henrissat, B. 2001; Glycoside hydrolases and glycosyltransferases: families and functional modules, Current Opinion in Structural Biology 11:593-600.

Examples of enzymes which comprise a CBM suitable for use in the context of the invention are endo-amylases (i.e. alpha-amylases in EC 3.2.1.1), maltogenic alpha-amylases (EC 3.2.1.133), glucoamylases (EC 3.2.1.3) and CGTases (EC 2.4.1.19).

An amylolytic enzyme comprising a CBM according to the invention may be a wild-type enzyme naturally comprising a CBM, or it may be a recombinant enzyme. In one embodiment of the invention an amylolytic enzyme comprising a CBM is a hybrid enzyme which comprises an amino acid sequence of a catalytic module having amylolytic activity and an amino acid sequence of a carbohydrate-binding module

Preferred for the invention is CBMs of Carbohydrate-Binding Module Family 20. CBMs of Carbohydrate-Binding Module Family 20 suitable for the invention may be derived from beta-amylases of Bacillus cereus (SWISSPROT P36924), or from CGTases of Bacillus circulans (SWISSPROT P43379). Also preferred for the invention is any CBM having at least 60%, at least 70%, at least 80% or even at least 90% identity to any of the afore mentioned CBM amino acid sequences. Further suitable CBMs of Carbohydrate-Binding Module Family 20 may be found at URL: http://afmb.cnrs-mrs.fr/˜cazy/CAZY/index.html).

Once a nucleotide sequence encoding the substrate-binding (carbohydrate-binding) region has been identified, either as cDNA or chromosomal DNA, it may then be manipulated in a variety of ways to fuse it to a DNA sequence encoding the enzyme activity of interest. The DNA fragment encoding the carbohydrate-binding amino acid sequence and the DNA encoding the enzyme of interest are then ligated with or without a linker. The resulting ligated DNA may then be manipulated in a variety of ways to achieve expression.

CBMs deriving from bacteria will generally be suitable for use in the context of the invention, however, preferred are CBMs of Bacillus origin, such as a CBM20 from Bacillus flavothermus (Syn. Anoxybacillus contaminans), preferably from amylase AMY1048 (SEQ ID NO:2 of WO 2005/003311), AMY1039, or AMY1079 (disclosed as respectively SEQ ID NO1, 2 and 3 in WO 2005/001064), the Bacillus amylases disclosed in WO 2002068589 from Diversa, Bacillus sp. TS23 (Korea) (Lin, L.-L.; Submitted (Mar. 1, 1995) to the EMBL/GenBank/DDBJ databases. Long-Liu Lin, Food Industry Research Institute, Culture Collection and Research Center, 331 Food Road, Hsinchu, Taiwan 300, Republic of China).

Hybrid enzymes or a genetically modified wild type enzymes as referred to herein include species comprising an amino acid sequence of an alpha-amylolytic enzyme (EC 3.2.1.1) linked (i.e. covalently bound) to an amino acid sequence comprising a carbohydrate-binding module (CBM).

CBM-containing hybrid enzymes, as well as detailed descriptions of the preparation and purification thereof, are known in the art [see, e.g. WO 90/00609, WO 94/24158 and WO 95/16782, as well as Greenwood et al. Biotechnology and Bioengineering 44 (1994) pp. 1295-1305]. They may, e.g. be prepared by transforming into a host cell a DNA construct comprising at least a fragment of DNA encoding the carbohydrate-binding module ligated, with or without a linker, to a DNA sequence encoding the enzyme of interest, and growing the transformed host cell to express the fused gene. The resulting recombinant product (hybrid enzyme)—often referred to in the art as a “fusion protein—may be described by the following general formula:

A-CBM-MR-X

In the latter formula, A-CBM is the N-terminal or the C-terminal region of an amino acid sequence comprising at least the carbohydrate-binding module (CBM) per se. MR is the middle region (the “linker”), and X is the sequence of amino acid residues of a polypeptide encoded by a DNA sequence encoding the enzyme (or other protein) to which the CBM is to be linked.

The moiety A may either be absent (such that A-CBM is a CBM per se, i.e. comprises no amino acid residues other than those constituting the CBM) or may be a sequence of one or more amino acid residues (functioning as a terminal extension of the CBM per se). The linker (MR) may be a bond, or a short linking group comprising from about 2 to about 100 carbon atoms, in particular of from 2 to 40 carbon atoms. However, MR is preferably a sequence of from about 2 to about 100 amino acid residues, more preferably of from 2 to 40 amino acid residues, such as from 2 to 15 amino acid residues.

The moiety X may constitute either the N-terminal or the C-terminal region of the overall hybrid enzyme.

It will thus be apparent from the above that the CBM in a hybrid enzyme of the type in question may be positioned C-terminally, N-terminally or internally in the hybrid enzyme.

In a preferred embodiment an amylolytic enzyme comprising a CBM according to the invention is an alpha-amylase comprising a starch binding domain, e.g. an acid alpha-amylase comprising a starch binding domain and having activity towards raw starch. An alpha-amylase comprising a starch binding domain suitable for use in the invention may be a hybrid enzyme or the polypeptide may be a wild type enzyme which already comprises a catalytic module having alpha-amylase activity and a starch binding domain. The polypeptide to be used in the process of the invention may also be a variant of such a wild type enzyme. Suitable alpha-amylases comprising a starch binding domain are disclosed in WO2005003311A2. Preferred is an amylase having the amino acid sequence disclosed in WO 2006/066579 as SEQ ID NO:2, SEQ ID NO:3 or SEQ ID NO:4, or in WO 2006/066596 as SEQ ID NO:2 or SEQ ID NO: 12, or any polypeptide having alpha-amylase activity and comprising a starch binding domain which polypeptide which has an amino acid sequence having at least 50%, at least 60%, at least 70%, at least 80%, at least 90% or even at least 95% identity to any of the aforementioned amino acid sequences.

In a particular embodiment the alpha-amylase is a bacterial alpha-amylase, preferably derived from a strain of B. licheniformis, B. amyloliquefaciens, and B. stearothermophilus alpha-amylase.

In the process of the invention the amylolytic enzyme comprising a CBM may be purified. The term “purified” as used herein covers amylolytic enzyme protein free from components from the organism from which it is derived. The term “purified” also covers amylolytic enzyme protein free from components from the native organism from which it is obtained, this is also termed “essentially pure” amylolytic enzyme and may be particularly relevant for amylolytic enzymes which are naturally occurring and which have not been modified genetically, such as by deletion, substitution or insertion of one or more amino acid residues.

Accordingly, the amylolytic enzyme comprising a CBM may be purified, viz. only minor amounts of other proteins being present. The expression “other proteins” relate in particular to other enzymes. The term “purified” as used herein also refers to removal of other components, particularly other proteins and most particularly other enzymes present in the cell of origin of the amylolytic enzyme. The amylolytic enzyme may be “substantially pure”, i.e. free from other components from the organism in which it is produced, i.e., e.g., a host organism for recombinantly produced amylolytic enzyme. Preferably, the enzymes are at least 75% (w/w) pure, more preferably at least 80%, 85%, 90% or even at least 95% pure. In a still more preferred embodiment the amylolytic enzyme is an at least 98% pure enzyme protein preparation.

The specific enzymes to be used in the process of the invention may be selected by the skilled person by methods well known in the art. An enzyme may be selected that has desired activity under the conditions of the part of the soy sauce process where the enzyme is desired to be active. E.g. an enzyme may be selected for its activity under the high NaCl concentration and low pH used in the soy sauce production process.

### Soy Sauce

Soy sauce is a light brown to black liquid-type condiment based on soy beans or soy bean derived material, with a meat-like, salty flavour, used as a seasoning, especially in oriental foods. In the production of soy sauce vegetable ingredients are used, such as e.g. soy beans or soy bean derived material, e.g. soy bean meal, defatted soy beans, and defatted soy bean meal; wheat; wheat derived material; rice; rice derived material; and barley. The main ingredients of soy sauce are usually soy beans or defatted soy bean meal, wheat, salt and water. Traditionally, soy sauce is made with a fermentation process, but unfermented soy sauce may also be produced.

Fermented soy sauce is usually produced in the following steps: preparation of koji, brine fermentation (moromi fermentation), filtration/pasteurization, and maturation.

Koji is usually prepared by mixing cooked soy beans or cooked defatted soy bean meal with roasted wheat. The mixture is then inoculated with a starter culture, usually of Aspergillus oryzae and/or Aspergillus sojae and left to ferment for a few days in a shallow bed for aerobic fermentation. After fermentation the koji is transferred to a tank for brine fermentation (moromi fermentation). Salt brine is added to a total NaCl content of usually 16-18% and it is usually inoculated with a yeast and lactic acid bacteria culture for further anaerobic fermentation. The resulting mixture is referred to as moromi. After a few days fermentation the raw soy sauce may be pressed from the moromi, filtered, pasteurised and left for fermentation, often for several months, or the moromi may be left for fermentation until the fermentation is finished, when it is filtered and bottled for consumption.

During the koji and the moromi fermentation processes carbohydrates, such as starch, are hydrolysed and the resulting sugars are fermented during the moromi fermentation to produce flavour and small amounts of alcohol and lactic acid, and protein is broken down into peptides and amino acids. These processes are important for the development of the typical complex flavour of fermented soy sauce.

Non-fermented soy sauce is usually prepared from hydrolysed vegetable proteins, typically acid hydrolysates of e.g. soy beans, defatted soy bean, wheat, wheat derived material, rice, rice derived material and/or barley, to which additional ingredients such as caramel colour, corn syrup and salt is added.

Soy sauce may be produced as reduced salt soy sauce. In the case of fermented soy sauce this is usually achieved by removing salt from the soy sauce by filtration and/or ion exchange. The finished soy sauce usually has a pH of 4-6.5 and a salt content of 13-22% NaCl (weight/weight), except for reduced salt soy sauce which usually has down to 6% NaCl.

### Enzymatic Treatment

The treatment of a vegetable material with an amylolytic enzyme comprising a CBM may be performed by any method known in the art. The treatment may e.g. be effected by adding the enzyme to a slurry of the vegetable material or by spraying the enzyme on the raw material. The enzyme may e.g. be added before or during a koji fermentation, or the enzyme may e.g. be added before or during a moromi fermentation. All of the ingredients of a soy sauce may be treated with the amylolytic enzyme at the same time, or one or more vegetable ingredients of the soy sauce may be treated before being mixed with additional ingredients. In one embodiment of the invention the vegetable material to be treated with an amylolytic enzyme comprises soy beans and/or soy bean derived material. In another embodiment of the invention the vegetable material to be treated with an amylolytic enzyme comprises wheat; wheat derived material, such as e.g. wheat flour or wheat starch; rice; and/or rice derived material, such as e.g. rice starch. The starch comprising ingredients may be treated with an amylolytic enzyme separately before being mixed with other ingredients of the soy sauce, e.g. wheat, wheat flour, wheat starch, rice and/or rice starch may be treated separately with an amylolytic enzyme, and soy beans and/or soy bean derived material, as well as other ingredients, may be added after treatment with an amylolytic enzyme. Thus, in one embodiment of the invention soy beans and/or soy bean derived material is added to the treated vegetable material after step i).

The amount of enzyme used should be sufficient to increase the starch hydrolysis compared to the starch hydrolysis of the koji culture itself. In one embodiment of the invention the amount of amylolytic enzyme comprising a CBM is sufficient to increase the degree of starch hydrolysis compared to a similar process where no amylolytic enzyme is added. In another embodiment of the invention the amount of amylolytic enzyme comprising a CBM is sufficient to increase the degree of starch hydrolysis compared to a similar process where an amylolytic enzyme without a CBM is added. The amylolytic enzyme comprising a CBM should be added in an amount so that it has sufficient activity under the conditions of the soy sauce process where the enzyme must work, such as e.g. temperature between 25 and 45° C., and salt (NaCl) concentration in the moromi fermentation step of e.g. 17-18%.

In one embodiment the invention relates to soy sauce obtainable by, or obtained by, the method of the invention. In a further embodiment the invention relates to use of an amylolytic enzyme comprising a carbohydrate binding module for production of soy sauce.

### EXAMPLE 1

### Enzymes

Two Bacterial Alpha-Amylase with a CBM:

AMY1048: The amino acid sequence is given as SEQ ID NO:2 in WO 2006/066596. A wildtype alpha-amylase from Bacillus flavothermus (Syn. Anoxybacillus contaminans) which comprises a CBM. The catalytic domain is amino acids 1 to 484 and the CBM is amino acids 485 to 586 of SEQ ID NO:2 of WO 2006/066596.

AX379+CBM: The amino acid sequence is given as SEQ ID NO:12 in WO 2006/066596. The enzyme is a hybrid of a Bacillus alpha-amylase and the CBM from AMY1048.

Two Bacterial Alpha-Amylases Without a CBM:

AMY1048 without CBM: The amino acid sequence is given as amino acids 1-484 of SEQ ID NO:2 in WO 2006/066596.

AX379: The amino acid sequence is given as amino acids 1-484 of SEQ ID NO:12 in WO 2006/066596.

The example illustrates the hydrolysis of wheat flour into soluble oligosaccharides as measured by an increase in reducing ends using bacterial alpha-amylase. A slurry with 1% (weight/weight) dry solids (DS) wheat flour was prepared in 50 mM Na-acetate pH 5.0, 20% NaCl. 1 mL of the wheat flour slurry was distributed to test tubes. The test tubes were incubated on a thermomixer at 25° C. At zero minutes the enzyme was dosed (160 micrograms/gram dry solids) to the test tube. Samples were withdrawn after 36, 64, and 90 minutes.

The release of oligosaccharides was determined by measuring the increase in reducing ends using the DNS-reagent method:

DNS-reagent: 1 g 3,5-dinitrosalicylic acid is dissolved in 20 ml 2 N NaOH and 50 ml water and subsequently 30 g Rochelle salt (Potassium sodium tartrate tetrahydrat) is added and the solution is heated to approximately 70° C. and subsequently adjusted to 100 ml with water.

Released reducing sugars was determined by incubating 50 microliters reaction mixture with 50 microliters DNS-reagent for 10 min at 100° C. After boiling, 250 microliters water was added and the absorbance at 550 nm was measured. The amount of released reducing sugars was quantified using a D-glucose standard curve. The results are shown in table 1.

TABLE 1

| | mM Glucose released with each enzyme | | | |
|---|---|---|---|---|
| Time | | | | AMY1048 |
| (minutes) | AX379 + CBM | AX379 | AMY1048 | without CBM |
| 0 | 0 | 0 | 0 | 0 |
| 36 | 4.5 | 2.9 | 2.1 | 1.6 |
| 64 | 5.5 | 3.7 | 2.9 | 1.8 |
| 90 | 6.0 | 4.5 | 3.7 | 2.0 |

1-13. (canceled)

14. A method for producing soy sauce, comprising:
(a) treating a vegetable material with an amylolytic enzyme; and
(b) producing soy sauce from the treated vegetable material;
wherein the amylolytic enzyme comprises a carbohydrate binding module.

15. The method of claim 14, wherein the amylolytic enzyme is added before or during a moromi fermentation process.

16. The method of claim 14, wherein the amylolytic enzyme is added before or during a koji fermentation process.

17. The method of claim 14, wherein the amylolytic enzyme is an alpha-amylase comprising a Carbohydrate Binding Module.

18. The method of claim 17, wherein the amylolytic enzyme is a bacterial alpha-amylase comprising a Carbohydrate Binding Module.

19. The method of claim 14, wherein the vegetable material comprises soy beans and/or soy bean derived material.

20. The method of claim 14, further comprising adding soy beans and/or soy bean derived material to the treated vegetable material after step (a).

21. The method of claim 14, wherein the vegetable material comprises wheat, wheat derived material, rice and/or rice derived material.

22. The method of claim 14, wherein the process comprises fermentation with a koji culture in step (b).

23. The method of claim 14, wherein the process comprises fermentation with a moromi culture in step (b).

24. The method of claim 14, wherein step (a) is performed during step (b).
